(19) United States
(12) Patent Application Publication
(10) Pub. No.: US 2025/0329775 A1
(43) Pub. Date: Oct. 23, 2025

(54) DOPED AND SUBSTITUTED SULFIDE-BASED SOLID-STATE ELECTROLYTES AND METHOD FOR MAKING THE SAME

(71) Applicant: UChicago Argonne, LLC, Chicago, IL (US)

(72) Inventors: Zachary David Hood, Bolingbrook, IL (US); Udochukwu Eze, Downers Grove, IL (US)

(73) Assignee: UChicago Argonne, LLC, Chicago, IL (US)

(21) Appl. No.: 18/642,444

(22) Filed: Apr. 22, 2024

(51) Int. Cl. H01M 10/0562; C01B 25/16; H01M 10/0525; H01M 10/0585

(52) U.S. Cl. CPC H01M 10/0562; C01B 25/16; H01M 10/0525; H01M 10/0585; C01P 2002/52; C01P 2002/85; C01P 2002/88; C01P 2006/40; H01M 2300/0071; H01M 2300/008

(57) ABSTRACT

A solid-state electrolyte material includes doped lithium argyrodite of formula of Li_{6-2a-b}MₐTCh_{5-a-b}OₐX_{1+b}; where 0<a≤0.5; 0<b≤0.5, M is Zn, Mg, Ca, Sr, Be or a combination of any two or more thereof; T is P, As, Sb, or a combination of any two or more thereof; Ch is S, Se, or a combination thereof; and X is F, Cl, Br, I, or a combination of any two or more thereof.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to solid electrolytes, particularly doped argyrodite type solid electrolytes.

### BACKGROUND

Solid-state lithium batteries are a class of electrochemical cells that include an anode, a cathode, and a solid electrolyte sandwiched between the anode and the cathode. The solid electrolyte is an ionically conductive material. When a solid-state lithium battery is charged, lithium ions move from the cathode to the anode via diffusion through the solid electrolyte. During discharging, lithium ions move from the anode to the cathode via diffusion through the solid electrolyte.

Advantages of solid electrolytes include improved safety, lack of toxic organic solvents, low flammability, non-volatility, thermal stability, low self-discharge, and higher achievable power density. However, there are still many limitations that hinder the large-scale adoption of solid electrolytes, due to their poor ionic conductivity compared to liquid electrolytes, their poor mechanical stability, and the high cost of the electrolyte precursors.

### SUMMARY

In an aspect, a solid-state electrolyte material is provided. The solid-state electrolyte includes doped lithium argyrodite of formula of Li_{6-2a-b}MₐTCh_{5-a-b}OₐX_{1+b}, wherein 0<a≤0.5; 0<b≤0.5, M is Zn, Mg, Ca, Sr, Be or a mixture of any two or more thereof; T is P, As, Sb, or a combination of any two or more thereof; Ch is S, Se, or a combination thereof; and X is F, Cl, Br, I, or a combination of any two or more thereof.

The solid-state electrolyte material at about 20° C. may have an ionic conductivity greater than about 2.0 mS cm⁻¹ and an electronic conductivity less than about 4×10⁻⁹ S cm⁻¹. The doped lithium argyrodite may be crystalline.

In another aspect, a solid-state lithium battery is provided. The solid-state battery includes a cathode layer, an anode layer, and a solid-state electrolyte layer disposed between the cathode layer and the anode layer, wherein at least one of the cathode layer and the solid-state electrolyte layer includes the solid-state electrolyte material disclosed herein.

The solid-state electrolyte layer may include about 10 wt. % to about 100 wt. % of the solid-state electrolyte material. The anode may include lithium metal.

In another aspect, a method of making a solid-state electrolyte material is provided. The method includes mixing powders of LiX, Li₂Ch, T₂Ch₅, and MO to form a mixture, where M is Zn, Mg, Ca, Sr, Be or a mixture of any two or more thereof; T is P, As, Sb, or a combination of any two or more thereof; Ch is S, Se, or a combination thereof; and X is F, Cl, Br, I, or a mixture of any two or more thereof; forming the mixture into a pellet, membrane, or film; and heating the pellet, membrane, or film to form the solid-state electrolyte.

Heating the pellet, membrane, or film may include heating the pellet, membrane, or film at about 450° C. to about 650° C. for about 3 hours to about 10 hours in an inert atmosphere substantially free of oxygen and water. Mixing may include mixing amounts of LiX, Li₂Ch, T₂Ch₅, and MO consistent with a stoichiometric of formula Li_{6-2a-b}MₐTCh_{5-a-b}OₐX_{1+b}, wherein 0<a≤0.5 and 0<b≤0.5. Mixing may include mixing in an inert atmosphere substantially free of oxygen and water.

In any embodiment, M may be Zn, Ca, or a combination thereof. M may be Zn, T may be P, and Ch may be S. X may be Cl. The doped lithium argyrodite of formula of Li_{6-2a-b}MₐTCh_{5-a-b}OₐX_{1+b} may include 0.2≤a≤0.3 and 0.2≤b≤0.3.

In another aspect, a solid-state electrolyte material is presented. The solid-state electrolyte material includes doped lithium argyrodite of formula of Li_{5.25}Zn_{0.25}PS_{4.5}O_{0.25}Cl_{1.25}.

### BRIEF DESCRIPTION OF THE DRAWINGS

FIG. 1 is a nonlimiting example of a lithium solid-state battery with a solid-state electrolyte including doped lithium argyrodite.

FIG. 2 is a flow chart of a method of making a doped lithium argyrodite.

FIG. 3A is a graph of XRD patterns of Li₆PS₅Cl, Li_{5.5}Zn_{0.25}PS_{4.75}O_{0.25}Cl, and Li_{5.25}Zn_{0.25}PS_{4.5}O_{0.25}Cl_{1.25} powders with the pattern of the Kapton film substrate shown for reference. The corresponding hkl planes for each argyrodite peak are labeled in parentheses. A zoomed in view from 29°-33° 310 shows the peak shift caused by the dopants.

FIG. 3B is a graph of XRD patterns of Li₆PS₅Cl and Li_{6-2a-b}ZnₐPS₅₋ₐOₐCl_{1+b} that was doped with ZnO (a=0.125, 0.25, and 0.5). Amounts of Li₂S and LiCl precipitated out of Li_{5.75}Zn_{0.125}PS_{4.875}O_{0.125}Cl and Li₅Zn_{0.5}PS_{4.5}O_{0.5}Cl while Li_{5.5}Zn_{0.25}PS_{4.75}O_{0.25}Cl crystalized into the argyrodite phase.

FIG. 3C shows elemental mapping of Li₆PS₅Cl, Li_{5.5}Zn_{0.25}PS_{4.75}O_{0.25}Cl, and Li_{5.25}Zn_{0.25}PS_{4.5}O_{0.25}Cl_{1.25} powders characterized with HAADF-STEM and EDS.

FIG. 4 is an Arrhenius plot of pellets made from Li₆PS₅Cl and members of the Li_{6-2x-y}ZnₓPS_{5-x-y}OₓCl_{1+y} phase space.

FIG. 5A shows the results of a current density test at 25° C. with a stack pressure of 6 MPa using Li∥Li symmetric cells over 50 hours. The current density was stepped from 0.05 mA cm⁻² to 2.0 mA cm⁻², with two cycles per current density. The length of each cycle was 2 hours.

FIG. 5B shows the results of a current density test at 25° C. with a stack pressure of 6 MPa using Li∥Li symmetric cells over 80 hours. The current density was stepped from 0.05 mA cm⁻² to 2.0 mA cm⁻², with two cycles per current density. The length of each cycle was 2 hours. The inset 510 shows a zoomed in image of the overpotentials for Li_{5.5}Zn_{0.25}PS_{4.75}O_{0.25}Cl and Li_{5.25}Zn_{0.25}PS_{4.5}O_{0.25}Cl_{1.25}.

FIG. 6 is a graph of Li∥Li symmetric cell cycling of Li_{5.5}Zn_{0.25}PS_{4.75}O_{0.25}Cl and Li_{5.25}Zn_{0.25}PS_{4.5}O_{0.25}Cl_{1.25} at 25° C. and a stack pressure of 6 MPa using a current density of 2.0 mA cm⁻².

FIG. 7A is a graph of weight gain of Li₆PS₅Cl, Li_{5.5}Zn_{0.25}PS_{4.75}O_{0.25}Cl, Li_{5.25}Zn_{0.25}PS_{4.5}O_{0.25}Cl_{1.25} powders during exposure to O₂ gas as measured by thermogravimetric analysis (TGA).

FIG. 7B is a graph of weight gain of Li₆PS₅Cl, Li_{5.5}Zn_{0.25}PS_{4.75}O_{0.25}Cl, Li_{5.25}Zn_{0.25}PS_{4.5}O_{0.25}Cl_{1.25} powders during exposure to humidified O₂ gas as measured by TGA.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Solid-state lithium batteries demonstrate exciting potential for improved safety as they replace the flammable liquid electrolyte in conventional Li-ion batteries with a non-flammable solid-state electrolyte. Argyrodite materials may be used as solid-state electrolytes (“SSEs”) in solid-state lithium batteries. The term “argyrodite” refers to the category of materials having a similar structure to silver germanium sulfide mineral (Ag₈GeS₆) commonly referred to as argyrodite mineral. The general chemical formula of the class of argyrodite solid electrolytes can be written as Li—P—S—X (where X=halide such as F, Br, Cl, I). More specifically, the argyrodite materials may be superionic conductors taking the form of Li₇₋ₐTCh₆₋ₐXₐ, where 0<a<1, T is phosphorous or arsenic, Ch is a chalcogen such as sulfur or selenium, and X is a halide (e.g., F, Cl, Br, or I). For example, lithium argyrodites with the composition of Li₆PS₅Cl exhibited a high ionic conductivity several orders of magnitude better than that of LiPON (˜10⁻⁶ S cm⁻¹) at room temperature.

However, argyrodite-type materials have certain challenges. Argyrodite-type materials can degrade at the interface between argyrodite-type materials and anodic or cathodic components. Interfacial contact between argyrodite and anodic or cathodic components may promote the degradation of argyrodite. This degradation can greatly reduce the ionic conductivity of the argyrodite-type material. The resulting loss in ionic conductivity has been attributed to decomposition and interface reactions that form insulating side products. The cost of the precursor materials used to form the argyrodite-type materials can also be a challenge. The precursor materials used to form argyrodite-type materials, such as Li₂S, can be cost-prohibitive in the amounts used to form the argyrodite-type materials at industrial scale. Additional challenges include air sensitivity, which creates manufacturing and ease-of-use challenges.

Disclosed herein are solid-state inorganic electrolytes for solid-state electrochemical cells that address these challenges. Also disclosed are processes for fabricating these inorganic electrolytes, and solid-state electrochemical cells including these inorganic electrolytes. The inorganic electrolytes include doped lithium argyrodite materials, where doping may include doping with a metal oxide, increasing the halide concentration in the material, or a combination thereof.

The doped lithium argyrodite may have the formula of Li_{6-2a-b}MₐTCh_{5-a-b}OₐX_{1+b}; where 0<a≤0.5; 0<b≤0.5; M is Zn, Mg, Ca, Sr, Be or a combination of any two or more thereof; T is P, As, Sb, or a combination of any two or more thereof; Ch is S, Se, or a combination thereof; and X is F, Cl, Br, I, or a combination of any two or more thereof. For example, the doped lithium argyrodite may have the formula of Li_{6-2a-b}MₐTCh_{5-a-b}OₐX_{1+b}; where a is 0.05 to 0.5, 0.1 to 0.5, 0.125 to 0.5, 0.2 to 0.5, 0.2 to 0.3, 0.05, 0.1, 0.15, 0.2, 0.25, 0.3, 0.35, 0.4, 0.45, 0.5, or any value therebetween; and where b is 0.05 to 0.5, 0.1 to 0.5, 0.125 to 0.5, 0.2 to 0.5, 0.2 to 0.3, 0.05, 0.1, 0.15, 0.2, 0.25, 0.3, 0.35, 0.4, 0.45, 0.5, or any value therebetween.

The doped lithium argyrodite may be doped with a single metal oxide, so that the formula is Li_{6-2a-b}MₐTCh_{5-a-b}OₐX_{1+b}. For example, the doped lithium argyrodite may be doped with ZnO, so that M is Zn, and the formula is Li_{6-2a-b}ZnₐTCh_{5-a-b}OₐX_{1+b}. As another example, the doped lithium argyrodite may be doped with CaO, so that M is Ca, and the formula is Li_{6-2a-b}CaₐTCh_{5-a-b}OₐX_{1+b}.

The doped lithium argyrodite may be doped with two metal oxides, so that M is a combination of M1 and M2, and the formula is Li_{6-2a-b}(M1_{c}M2_{1-c})ₐTCh_{5-a-b}OₐX_{1+b}, where 0<c<1. For example, the doped lithium argyrodite may be doped with ZnO and CaO, so that M is a combination of Zn and Ca, and the formula is Li_{6-2a-b}(Zn_{c}Ca_{1-c})ₐTCh_{5-a-b}OₐX_{1+b}, where 0<c<1 (e.g., c may be about 0.1 to about 0.9, about 0.2 to about 0.8, or about 0.5).

The doped lithium argyrodite may include phosphorus so that T is P, and the formula is Li_{6-2a-b}MₐPCh_{5-a-b}OₐX_{1+b}. For example, the doped lithium argyrodite may be Li_{6-2a-b}ZnₐPCh_{5-a-b}OₐX_{1+b}, Li_{6-2a-b}CaₐPCh_{5-a-b}OₐX_{1+b}, Li_{6-2a-b}(Zn_{c}Ca_{1-c})ₐPCh_{5-a-b}OₐX_{1+b}, or a combination of any two or more thereof.

The doped lithium argyrodite may include arsenic so that T is As, and the formula is Li_{6-2a-b}MₐAsCh_{5-a-b}OₐX_{1+b}. For example, the doped lithium argyrodite may be Li_{6-2a-b}ZnₐAsCh_{5-a-b}OₐX_{1+b}, Li_{6-2a-b}CaₐAsCh_{5-a-b}OₐX_{1+b}, Li_{6-2a-b}(Zn_{c}Ca_{1-c})ₐAsCh_{5-a-b}OₐX_{1+b}, or a combination of any two or more thereof.

The doped lithium argyrodite may include antimony so that T is Sb, and the formula is Li_{6-2a-b}MₐSbCh_{5-a-b}OₐX_{1+b}. For example, the doped lithium argyrodite may be Li_{6-2a-b}ZnₐSbCh_{5-a-b}OₐX_{1+b}, Li_{6-2a-b}CaₐSbCh_{5-a-b}OₐX_{1+b}, Li_{6-2a-b}(Zn_{c}Ca_{1-c})ₐSbCh_{5-a-b}OₐX_{1+b}, or a combination of any two or more thereof.

The doped lithium argyrodite may include sulfur so that Ch is S, and the formula is Li_{6-2a-b}MₐS_{5-a-b}OₐX_{1+b}. For example, the doped lithium argyrodite may be Li_{6-2a-b}ZnₐPS_{5-a-b}OₐX_{1+b}, Li_{6-2a-b}ZnₐAsS_{5-a-b}OₐX_{1+b}, Li_{6-2a-b}ZnₐSbS_{5-a-b}OₐX_{1+b}, Li_{6-2a-b}CaₐPS_{5-a-b}OₐX_{1+b}, Li_{6-2a-b}CaₐAsS_{5-a-b}OₐX_{1+b}, Li_{6-2a-b}CaₐSbS_{5-a-b}OₐX_{1+b}, Li_{6-2a-b}(Zn_{c}Ca_{1-c})ₐPS_{5-a-b}OₐX_{1+b}, Li_{6-2a-b}(Zn_{c}Ca_{1-c})ₐAsS_{5-a-b}OₐX_{1+b}, Li_{6-2a-b}(Zn_{c}Ca_{1-c})ₐSbS_{5-a-b}OₐX_{1+b}, or a combination of any two or more thereof.

The doped lithium argyrodite may include selenium so that Ch is Se, and the formula is Li_{6-2a-b}MₐSe_{5-a-b}OₐX_{1+b}. For example, the doped lithium argyrodite may be Li_{6-2a-b}ZnₐPSe_{5-a-b}OₐX_{1+b}, Li_{6-2a-b}ZnₐAsSe_{5-a-b}OₐX_{1+b}, Li_{6-2a-b}ZnₐSbSe_{5-a-b}OₐX_{1+b}, Li_{6-2a-b}CaₐPSe_{5-a-b}OₐX_{1+b}, Li_{6-2a-b}CaₐAsSe_{5-a-b}OₐX_{1+b}, Li_{6-2a-b}CaₐSbSe_{5-a-b}OₐX_{1+b}, Li_{6-2a-b}(Zn_{c}Ca_{1-c})ₐPSe_{5-a-b}OₐX_{1+b}, Li_{6-2a-b}(Zn_{c}Ca_{1-c})ₐAsSe_{5-a-b}OₐX_{1+b}, Li_{6-2a-b}(Zn_{c}Ca_{1-c})ₐSbSe_{5-a-b}OₐX_{1+b}, or a combination of any two or more thereof.

The doped lithium argyrodite may include sulfur and selenium so that Ch is (S_{d}Se_{1-d}), where 0<d<1, and the formula is Li_{6-2a-b}Mₐ(S_{d}Se_{1-d})_{5-a-b}OₐX_{1+b}. For example, the doped lithium argyrodite may be Li_{6-2a-b}ZnₐP(S_{d}Se_{1-d})_{5-a-b}OₐX_{1+b}, Li_{6-2a-b}ZnₐAs(S_{d}Se_{1-d})_{5-a-b}OₐX_{1+b}, Li_{6-2a-b}ZnₐSb(S_{d}Se_{1-d})_{5-a-b}OₐX_{1+b}, Li_{6-2a-b}CaₐP(S_{d}Se_{1-d})_{5-a-b}OₐX_{1+b}, Li_{6-2a-b}CaₐAs(S_{d}Se_{1-d})_{5-a-b}OₐX_{1+b}, Li_{6-2a-b}CaₐSb(S_{d}Se_{1-d})_{5-a-b}OₐX_{1+b}, Li_{6-2a-b}(Zn_{c}Ca_{1-c})ₐP(S_{d}Se_{1-d})_{5-a-b}OₐX_{1+b}, Li_{6-2a-b}(Zn_{c}Ca_{1-c})ₐAs(S_{d}Se_{1-d})_{5-a-b}OₐX_{1+b}, Li_{6-2a-b}(Zn_{c}Ca_{1-c})ₐSb(S_{d}Se_{1-d})_{5-a-b}OₐX_{1+b}, or a combination of any two or more thereof.

The doped lithium argyrodite may include chlorine so that X is Cl, and the formula is Li_{6-2a-b}MₐTCh_{5-a-b}OₐCl_{1+b}. For example the doped lithium argyrodite may be Li_{6-2a-b}ZnₐPS_{5-a-b}OₐCl_{1+b}, Li_{6-2a-b}ZnₐAsS_{5-a-b}OₐCl_{1+b}, Li_{6-2a-b}ZnₐSbS_{5-a-b}OₐCl_{1+b}, Li_{6-2a-b}CaₐPS_{5-a-b}OₐCl_{1+b}, Li_{6-2a-b}CaₐAsS_{5-a-b}OₐCl_{1+b}, Li_{6-2a-b}CaₐSbS_{5-a-b}OₐCl_{1+b}, Li_{6-2a-b}(Zn_{c}Ca_{1-c})ₐPS_{5-a-b}OₐCl_{1+b}, Li_{6-2a-b}(Zn_{c}Ca_{1-c})ₐAsS_{5-a-b}OₐCl_{1+b}, Li_{6-2a-b}(Zn_{c}Ca_{1-c})ₐSbS_{5-a-b}OₐCl_{1+b} Li_{6-2a-b}ZnₐPSe_{5-a-b}OₐCl_{1+b}, Li_{6-2a-b}ZnₐAsSe_{5-a-b}OₐCl_{1+b}, Li_{6-2a-b}ZnₐSbSe_{5-a-b}OₐCl_{1+b}, Li_{6-2a-b}CaₐPSe_{5-a-b}OₐCl_{1+b}, Li_{6-2a-b}CaₐAsSe_{5-a-b}OₐCl_{1+b}, Li_{6-2a-b}CaₐSbSe_{5-a-b}OₐCl_{1+b}, Li_{6-2a-b}(Zn_{c}Ca_{1-c})ₐPSe_{5-a-b}OₐCl_{1+b}, Li_{6-2a-b}(Zn_{c}Ca_{1-c})ₐAsSe_{5-a-b}OₐCl_{1+b}, Li_{6-2a-b}(Zn_{c}Ca_{1-c})ₐSbSe_{5-a-b}OₐCl_{1+b}, Li_{6-2a-b}ZnₐP(S_{d}Se_{1-d})_{5-a-b}OₐCl_{1+b}, Li_{6-2a-b}ZnₐAs(S_{d}Se_{1-d})_{5-a-b}OₐCl_{1+b}, Li_{6-2a-b}ZnₐSb(S_{d}Se_{1-d})_{5-a-b}OₐCl_{1+b}, Li_{6-2a-b}CaₐP(S_{d}Se_{1-d})_{5-a-b}OₐCl_{1+b}, Li_{6-2a-b}CaₐAs(S_{d}Se_{1-d})_{5-a-b}OₐCl_{1+b}, Li_{6-2a-b}CaₐSb(S_{d}Se_{1-d})_{5-a-b}OₐCl_{1+b}, Li_{6-2a-b}(Zn_{c}Ca_{1-c})ₐP(S_{d}Se_{1-d})_{5-a-b}OₐCl_{1+b}, Li_{6-2a-b}(Zn_{c}Ca_{1-c})ₐAs(S_{d}Se_{1-d})_{5-a-b}OₐCl_{1+b}, Li_{6-2a-b}(Zn_{c}Ca_{1-c})ₐSb(S_{d}Se_{1-d})_{5-a-b}OₐCl_{1+b}, or a combination of any two or more thereof.

The doped lithium argyrodite may include bromine so that X is Br, and the formula is Li_{6-2a-b}MₐTCh_{5-a-b}OₐBr_{1+b}. For example the doped lithium argyrodite may be Li_{6-2a-b}ZnₐPS_{5-a-b}OₐBr_{1+b}, Li_{6-2a-b}ZnₐAsS_{5-a-b}OₐBr_{1+b}, Li_{6-2a-b}ZnₐSbS_{5-a-b}OₐBr_{1+b}, Li_{6-2a-b}CaₐPS_{5-a-b}OₐBr_{1+b}, Li_{6-2a-b}CaₐAsS_{5-a-b}OₐBr_{1+b}, Li_{6-2a-b}CaₐSbS_{5-a-b}OₐBr_{1+b}, Li_{6-2a-b}(Zn_{c}Ca_{1-c})ₐPS_{5-a-b}OₐBr_{1+b}, Li_{6-2a-b}(Zn_{c}Ca_{1-c})ₐAsS_{5-a-b}OₐBr_{1+b}, Li_{6-2a-b}(Zn_{c}Ca_{1-c})ₐSbS_{5-a-b}OₐBr_{1+b}, Li_{6-2a-b}ZnₐPSe_{5-a-b}OₐBr_{1+b}, Li_{6-2a-b}ZnₐAsSe_{5-a-b}OₐBr_{1+b}, Li_{6-2a-b}ZnₐSbSe_{5-a-b}OₐBr_{1+b}, Li_{6-2a-b}CaₐPSe_{5-a-b}OₐBr_{1+b}, Li_{6-2a-b}CaₐAsSe_{5-a-b}OₐBr_{1+b}, Li_{6-2a-b}CaₐSbSe_{5-a-b}OₐBr_{1+b}, Li_{6-2a-b}(Zn_{c}Ca_{1-c})ₐPSe_{5-a-b}OₐBr_{1+b}, Li_{6-2a-b}(Zn_{c}Ca_{1-c})ₐAsSe_{5-a-b}OₐBr_{1+b}, Li_{6-2a-b}(Zn_{c}Ca_{1-c})ₐSbSe_{5-a-b}OₐBr_{1+b}, Li_{6-2a-b}ZnₐP(S_{d}Se_{1-d})_{5-a-b}OₐBr_{1+b}, Li_{6-2a-b}ZnₐAs(S_{d}Se_{1-d})_{5-a-b}OₐBr_{1+b}, Li_{6-2a-b}ZnₐSb(S_{d}Se_{1-d})_{5-a-b}OₐBr_{1+b}, Li_{6-2a-b}CaₐP(S_{d}Se_{1-d})_{5-a-b}OₐBr_{1+b}, Li_{6-2a-b}CaₐAs(S_{d}Se_{1-d})_{5-a-b}OₐBr_{1+b}, Li_{6-2a-b}CaₐSb(S_{d}Se_{1-d})_{5-a-b}OₐBr_{1+b}, Li_{6-2a-b}(Zn_{c}Ca_{1-c})ₐP(S_{d}Se_{1-d})_{5-a-b}OₐBr_{1+b}, Li_{6-2a-b}(Zn_{c}Ca_{1-c})ₐAs(S_{d}Se_{1-d})_{5-a-b}OₐBr_{1+b}, Li_{6-2a-b}(Zn_{c}Ca_{1-c})ₐSb(S_{d}Se_{1-d})_{5-a-b}OₐBr_{1+b}, or a combination of any two or more thereof.

The doped lithium argyrodite may include chlorine and bromine so that X is (ClₑBr₁₋ₑ), where 0<e<1, and the formula is Li_{6-2a-b}MₐTCh_{5-a-b}OₐBr_{1+b}. For example the doped lithium argyrodite may be Li_{6-2a-b}ZnₐPS_{5-a-b}Oₐ(ClₑBr₁₋ₑ)_{1+b}, Li_{6-2a-b}ZnₐAsS_{5-a-b}Oₐ(ClₑBr₁₋ₑ)_{1+b}, Li_{6-2a-b}ZnₐSbS_{5-a-b}Oₐ(ClₑBr₁₋ₑ)_{1+b}, Li_{6-2a-b}CaₐPS_{5-a-b}Oₐ(ClₑBr₁₋ₑ)_{1+b}, Li_{6-2a-b}CaₐAsS_{5-a-b}Oₐ(ClₑBr₁₋ₑ)_{1+b}, Li_{6-2a-b}CaₐSbS_{5-a-b}Oₐ(ClₑBr₁₋ₑ)_{1+b}, Li_{6-2a-b}(Zn_{c}Ca_{1-c})ₐPS_{5-a-b}Oₐ(ClₑBr₁₋ₑ)_{1+b}, Li_{6-2a-b}(Zn_{c}Ca_{1-c})ₐAsS_{5-a-b}Oₐ(ClₑBr₁₋ₑ)_{1+b}, Li_{6-2a-b}(Zn_{c}Ca_{1-c})ₐSbS_{5-a-b}Oₐ(ClₑBr₁₋ₑ)_{1+b}, Li_{6-2a-b}ZnₐPSe_{5-a-b}Oₐ(ClₑBr₁₋ₑ)_{1+b}, Li_{6-2a-b}ZnₐAsSe_{5-a-b}Oₐ(ClₑBr₁₋ₑ)_{1+b}, Li_{6-2a-b}ZnₐSbSe_{5-a-b}Oₐ(ClₑBr₁₋ₑ)_{1+b}, Li_{6-2a-b}CaₐPSe_{5-a-b}Oₐ(ClₑBr₁₋ₑ)_{1+b}, Li_{6-2a-b}CaₐAsSe_{5-a-b}Oₐ(ClₑBr₁₋ₑ)_{1+b}, Li_{6-2a-b}CaₐSbSe_{5-a-b}Oₐ(ClₑBr₁₋ₑ)_{1+b}, Li_{6-2a-b}(Zn_{c}Ca_{1-c})ₐPSe_{5-a-b}Oₐ(ClₑBr₁₋ₑ)_{1+b}, Li_{6-2a-b}(Zn_{c}Ca_{1-c})ₐAsSe_{5-a-b}Oₐ(ClₑBr₁₋ₑ)_{1+b}, Li_{6-2a-b}(Zn_{c}Ca_{1-c})ₐSbSe_{5-a-b}Oₐ(ClₑBr₁₋ₑ)_{1+b}, Li_{6-2a-b}ZnₐP(S_{d}Se_{1-d})_{5-a-b}Oₐ(ClₑBr₁₋ₑ)_{1+b}, Li_{6-2a-b}ZnₐAs(S_{d}Se_{1-d})_{5-a-b}Oₐ(ClₑBr₁₋ₑ)_{1+b}, Li_{6-2a-b}ZnₐSb(S_{d}Se_{1-d})_{5-a-b}Oₐ(ClₑBr₁₋ₑ)_{1+b}, Li_{6-2a-b}CaₐP(S_{d}Se_{1-d})_{5-a-b}Oₐ(ClₑBr₁₋ₑ)_{1+b}, Li_{6-2a-b}CaₐAs(S_{d}Se_{1-d})_{5-a-b}Oₐ(ClₑBr₁₋ₑ)_{1+b}, Li_{6-2a-b}CaₐSb(S_{d}Se_{1-d})_{5-a-b}Oₐ(ClₑBr₁₋ₑ)_{1+b}, Li_{6-2a-b}(Zn_{c}Ca_{1-c})ₐP(S_{d}Se_{1-d})_{5-a-b}Oₐ(ClₑBr₁₋ₑ)_{1+b}, Li_{6-2a-b}(Zn_{c}Ca_{1-c})ₐAs(S_{d}Se_{1-d})_{5-a-b}Oₐ(ClₑBr₁₋ₑ)_{1+b}, Li_{6-2a-b}(Zn_{c}Ca_{1-c})ₐSb(S_{d}Se_{1-d})_{5-a-b}Oₐ(ClₑBr₁₋ₑ)_{1+b}, or a combination of any two or more thereof.

The doped lithium argyrodite may be crystalline, polycrystalline, polyamorphous, or amorphous.

The ionic conductivity of the doped lithium argyrodite may be greater than 10⁻⁶ S cm⁻¹ at room temperature (i.e., 18° C. to 28° C. or about 25° C.). In any embodiment, the doped lithium argyrodite may have an ionic conductivity of about 0.05 mS cm⁻¹ to about 5 mS cm⁻¹ or about 0.5 mS cm⁻¹ to about 5 mS cm⁻¹. For example, the ionic conductivity of the doped lithium argyrodite may be about 0.05 mS cm⁻¹, 0.5 mS cm⁻¹, 1 mS cm⁻¹, 2 mS cm⁻¹, 3 mS cm⁻¹, 4 mS cm⁻¹, 5 mS cm⁻¹, or any value therebetween.

The electronic conductivity of the doped lithium argyrodite may be less than 10⁻¹⁰ S cm⁻¹ at room temperature. In any embodiment, the doped lithium argyrodite may have an electronic conductivity of about 10⁻⁷ S cm⁻¹ to about 10⁻¹⁰ S cm⁻¹ or 10⁻⁸ S cm⁻¹ to about 10⁻¹⁰ S cm⁻¹. For example, the ionic conductivity of the doped lithium argyrodite may be about 1×10⁻⁹ S cm⁻¹, 2×10⁻⁹ S cm⁻¹, 3×10⁻⁹ S cm⁻¹, 4×10⁻⁹ S cm⁻¹, 5×10⁻⁹ S cm⁻¹, 6×10⁻⁹ S cm⁻¹, 7×10⁻⁹ S cm⁻¹, 8×10⁻⁹ S cm⁻¹, 9×10⁻⁹ S cm⁻¹, or any value therebetween.

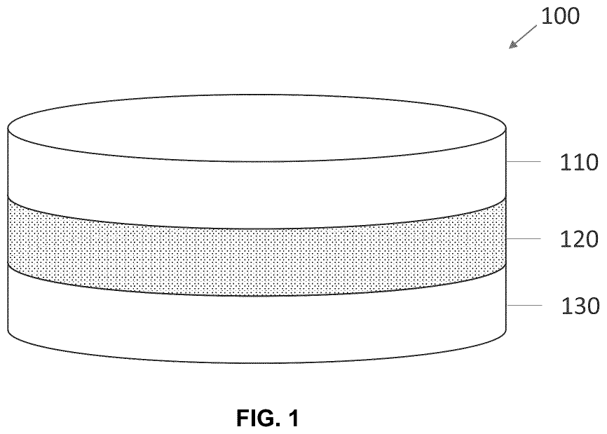

In another aspect, a solid-state lithium battery 100 is presented in FIG. 1. The solid-state lithium battery 100 includes a cathode layer 110, an anode layer 130, and a solid-state inorganic electrolyte layer 120, which includes the doped lithium argyrodite disclosed herein. The solid-state electrolyte layer 120 may be formed into a monolithic material (e.g., pellet, membrane, or film) for use in the solid-state lithium battery 100. For example, doped argyrodite powders may be cold pressed at a temperature of about 15° C. to about 30° C. (e.g., 25° C.) and a pressure of about 100 megapascals (MPa) to about 1500 MPa (e.g., 500 MPa to 1000 MPa, or 700 MPa) to form a pellet. For example, the doped argyrodite powders may be cast or spray-deposited as membranes or films (e.g., via solvent-based or dry processing methods). The cast or spray-deposition may be used, for example, in roll-to-roll processing for scalable manufacturing. The solid-state electrolyte layer 120 may include conductive additives and/or binders, as described in more detail below.

The solid-state electrolyte layer 120 includes about 10 wt. % to about 100 wt. % of the doped lithium argyrodite. For example, the solid-state electrolyte layer may include about 20 wt. % to about 95 wt. %, 40 wt. % to about 95 wt. %, 60 wt. % to about 95 wt. %, or any value therebetween.

The cathode 110 may be a composite including one or more active materials. In any embodiment, the cathode 110 may include a predetermined amount of the doped lithium argyrodite. The cathode 110 may also include conductive additives and/or binders, as described in more detail below. A mixture of cathode active materials and other components may be mixed in powdered form and then formed into a monolith. For example, the cathode materials may be pressed into a pellet to form the cathode. As another example, the cathode material may be cast or spray-deposited as membranes or films (e.g., via solvent-based or dry processing methods) to form the cathode.

Illustrative cathode active materials may include, but are not limited to, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, or VO₂. In the cathode active materials, M⁴ is Al, Mg, Ti, B, Ga, Si, Mn, or Co; M⁵ is Mg, Zn, Al, Ga, B, Sr, B, or Ti; A is Li, Ag, Cu, Na, Mn, Fe, Co, Ni, Cu, or Zn; 0≤x≤0.3; 0≤y≤0.5; 0≤z≤0.5; 0≤x″≤0.4; 0≤α≤1; 0≤β≤1; 0≤γ≤1; 0≤δ′≤0.4; and 0≤z″≤0.4; with the proviso that at least one of α, β and γ is greater than 0. In some embodiments, the cathode includes LiFePO₄, LiCoO₂, LiNiO₂, LiNi₁₋ₓCo_{y}M⁴_{z}O₂, LiMn_{0.5}Ni_{0.5}O₂, LiMn₃Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, and Li_{x′}(Met)O₂, wherein Met is a transition metal and 1<x′≤2. In some embodiments, Met is Ni, Co, Mn, or a mixture of any two or more thereof. In some embodiments, Met is a mixture of Ni, Co, and Mn.

The anode 130 may be a metal foil or composite. For example, the metal foil may be Li metal. In implementations where the anode is a composite, the composite may include one or more anode active materials. In any embodiment, the anode 130 may include a predetermined amount of the doped lithium argyrodite. The anode 130 may also include conductive additives and/or binders, as described in more detail below. A mixture of anode active materials and other components may be mixed in powdered form and then formed into a monolith. For example, the anode materials may be pressed into a pellet to form the anode. As another example, the cathode material may be cast or spray-deposited as membranes or films (e.g., via solvent-based or dry processing methods) to form the anode 130.

Illustrative anode materials include metallic anode active materials such as lithium, metal oxides, or carbon materials including, but not limited to, synthetic graphite, natural graphite, amorphous carbon, hard carbon, soft carbon, mesocarbon microbeads (MCMB). In any of the above embodiments, the anode may include a graphite material, alloys, intermetallics, silicon, silicon oxides, TiO₂ and Li₄Ti₅O₁₂, and composites thereof. For example, the anode active material may include a metallic anode material intercalated within a host material, where the metallic anode material includes lithium, and the host material may be an active carbon material including, but not limited to, synthetic graphite, natural graphite, amorphous carbon, hard carbon, soft carbon, mesocarbon microbeads (MCMB). In other embodiments, the metallic anode material includes lithium, and the metallic anode material is dispersed in a host material, which may be an alloy, intermetallic, silicon, silicon oxide, TiO₂, Li₄Ti₅O₁₂, or mixtures of any two or more thereof. In some embodiments, the anode active material is a lithiated carbon material such as lithiated graphite. Example anode materials for the lithium battery include, but are not limited to, Li metal, meso-carbon microbeads, natural graphite, synthetic graphite, soft carbon, hard carbon, and Si-based alloys.

The solid-state electrolyte layer 120, cathode layer 110, and/or anode layer 130 of the solid-state battery 100 may also include one or more conductive additives. In any embodiment, the conductive additive may be a conductive carbon. Examples of conductive carbons include synthetic graphite, natural graphite, amorphous carbon, hard carbon, soft carbon, acetylene black, mesocarbon microbeads (MCMB), carbon black, Ketjen© black, mesoporous carbon, porous carbon matrix, carbon nanotube, carbon nanofiber, and/or graphene.

The solid-state battery 100 may also include current collectors for the electrodes. Current collectors for the anode layer 130 and/or the cathode layer 110 may include those of copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys.

The solid-state electrolyte layer 120, cathode layer 110, and/or anode layer 130 of the solid-state battery 100 may include one or more binder that holds the electrode active material and other materials in the electrode to the current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

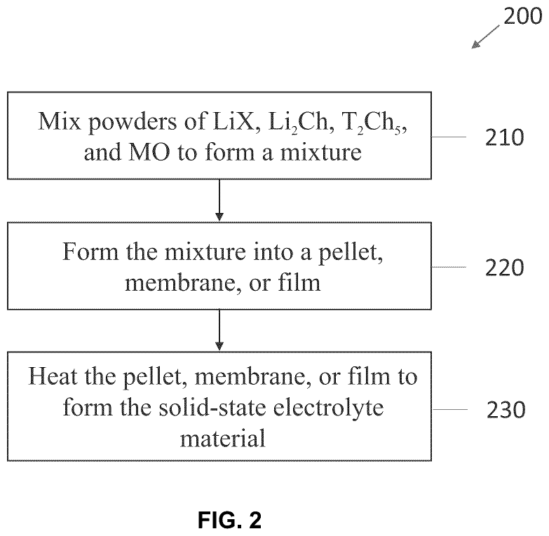

In another aspect, a method 200 of making a solid-state electrolyte material including the doped lithium argyrodite disclosed herein is presented, as illustrated in the flow diagram in FIG. 2. The method includes the step 210 of mixing powders of LiX, Li₂Ch, T₂Ch₅, and MO to form a mixture, where M is Zn, Mg, Ca, Sr, Be or a mixture of any two or more thereof; T is P, As, Sb, or a combination of any two or more thereof; Ch is S, Se, or a combination thereof; and X is F, Cl, Br, I, or a mixture of any two or more thereof. In step 220, the mixture is then formed into a monolithic form (e.g., a pellet, membrane, or film). In step 230, the monolithic form is heated to form the doped lithium argyrodite solid-state electrolyte material. Following heat treatment, the doped lithium argyrodite solid-state electrolyte material may be used as a solid-state electrolyte, or may be mixed with other components (e.g., other electrolyte materials, binders, and/or conductive additives) to form the solid-state electrolyte. For example, the doped lithium argyrodite solid-state electrolyte material may be ground to a powder and mixed with a binder and/or conductive additive, as described herein, before being pressed to form a solid-state electrolyte for a solid-state battery.

The powders of LiX, Li₂Ch, T₂Ch₅, and MO may be mixed in predetermined amounts consistent with the stoichiometry of the doped lithium argyrodite having the formula Li_{6-2a-b}MₐTCh_{5-a-b}OₐX_{1+b}, wherein 0<a≤0.5 and 0<b≤0.5.

The steps of mixing the powders 210, forming the monolithic form 220, and heating the monolithic form 230 may be conducted in an inert atmosphere substantially free of oxygen and water. For example, the steps of mixing and forming the monolithic form 210 may be conducted in a glove box filled with an inert gas (e.g., argon gas) and substantially free of O₂ and H₂O (e.g., having less than 0.5 ppm of O₂ and H₂O); and the step of heating may be conducted in a sealed container filled with an inert gas (e.g., argon gas) and substantially free of O₂ and H₂O.

The step of heating the monolithic form of the doped lithium argyrodite 230 may include heating at about 450° C. to about 650° C. for about 3 hours to about 24 hours in an inert atmosphere substantially free of oxygen and water. For example, the doped lithium argyrodite may be heated at about 450° C. to about 550° C., about 470° C. to about 530° C., about 480° C. to about 520° C., about 490° C. to about 510° C., or about 500° C. The doped lithium argyrodite may be heated for about 3 hours to about 10 hours, about 4 hours to about 6 hours, about 7 hours to about 9 hours, about 5 hours, or about 8 hours.

The present invention, thus generally described, will be understood more readily by reference to the following examples, which are provided by way of illustration and are not intended to be limiting of the present invention.

### EXAMPLES

Li₆PS₅Cl was doped with zinc oxide (ZnO) and enriched with chlorine to address challenges with using argyrodite-type materials as solid-state electrolytes, including air stability, interfacial resistance with active materials, and cost of argyrodite precursors. ZnO alloyed with Li metal has a higher electronegativity compared to sulfur (which can reduce bulk electronic conductivity), and may inhibit reactions with air and moisture. Furthermore, chlorine enrichment may increase the bulk ionic conductivity of argyrodite-type materials and improve air stability by substituting sulfur atoms in the material with chlorine.

### Methods

Materials synthesis. LiCl (99+%, Thermo Fisher Scientific), Li₂S (99.9%, Thermo Fisher Scientific), P₂S₅ (98+%, Acros Organics), and ZnO (NanoTek, Alfa Aesar) were used as synthesis precursors. To make Li₆PS₅Cl, stoichiometric amounts of LiCl, Li₂S, and P₂S₅ powders were mixed and ground for 2 minutes to 3 minutes using a mortar and pestle. The resulting powder mixture was pressed at 700 MPa at room temperature into a 0.5 inch diameter pellet and placed in a zirconia crucible. The crucible and pellet were placed in a steel container which was then sealed under argon gas using a copper gasket. The sealed container was placed in a furnace and the pellet was heated at 550° C. for 3 hours. To make Li_{6-2a-b}ZnₐPS_{5-a-b}OₐCl_{1+b} (a=0.125, 0.25, or 0.5; b≤0.25), stoichiometric amounts of LiCl, Li₂S, P₂S₅, and ZnO powders were mixed and ground for 2-3 minutes using a mortar and pestle. The resulting powder mixture was pressed at 700 MPa at room temperature into a 0.5 inch diameter pellet and placed in a zirconia crucible. The crucible and pellet were placed in a steel container which was then sealed under argon using a copper gasket. The sealed container was placed in a furnace and the pellet was heated at 500° C. for 5 hours or 8 hours. All processes except for the heating were carried out in an argon-filled glove box.

Characterization. X-ray powder diffraction was carried out on a Bruker D8 Discover with Cu-Kα radiation (λ=1.5418 Å) for phase identification of the produced samples. The morphology was observed using field-emission scanning electron microscopy (FE-SEM) on Phantom SEM. Scanning transmission electron microscopy (STEM) and Energy-Dispersive X-ray Spectroscopy (EDS) was performed on an FEI Talos TEM/STEM equipped with a Bruker EDS detector operated at 200 kV. The specimens were prepared by depositing powder onto lacey-carbon-coated TEM grids inside an Argon-filled glove box. All grids were transferred to the TEM under Argon. The electron beam was carefully tuned to minimize any electron-beam-induced damage to the materials. For air stability studies, pellet mass gain was measured using a thermogravimetric analyzer (TGA, TA Instruments) under a flow of O₂ or O₂ bubbled through deionized H₂O to form humidified O₂.

Electrochemical measurements. For electrochemical impedance spectroscopy (EIS) measurements, symmetric cells of Al/C on opposite sides of the solid-state electrolyte (Al/C∥SSE∥AlC) as blocking electrodes. EIS measurements were completed on a Biologic potentiostat with a frequency range between 7 MHz-1 Hz under an applied amplitude of 100 mV. Arrhenius plots were collected between −20° C. and 100° C. in a forced air environmental chamber. Symmetric cells of Li∥SSE∥Li were assembled by using an air-tight, in-house-designed pressed cell (stack pressure: 6 MPa) and cycled at different current densities (0.05 mA cm⁻²-2.0 mA cm⁻²) in an oven kept at 25° C.

### Results and Discussion

Doping Effects on Argyrodite Structure: A Tale of Two Sites. Li₆PS₅Cl (LPSC) and compounds of Li_{6-2a-b}ZnₐPS₅₋ₐOₐCl_{1+b} (LZPSOC) were synthesized by hand grinding stoichiometric ratios of the precursors Li₂S, P₂S₅, LiCl, and ZnO. The resultant powder mixtures were pressed into pellets and heated at temperatures of about 500-550° C. The pellets were then manually ground into powders of desired particle size. All materials were handled in a glove box filled with argon gas (<0.5 ppm H₂O and O₂ content). Concentrations of ZnO (LZPSOC stoichiometric amounts where a=0.125, 0.25, and 0.5) were chosen to achieve a predetermined number of Zn and O atoms per unit cell. The total number of atoms in the unit cell of Li_{6-2a-b}ZnₐPS₅₋ₐOₐCl_{1+b} can be obtained by multiplying the molecular formula by four (Li_{24-8a-4b}Zn₄ₐP₄S₂₀₋₄ₐO₄ₐCl₄₊₄b). Doping ZnO at a=0.125, 0.25, and 0.5 resulted in one-half, one, and two Zn and O atoms per unit cell, respectively. Chlorine was enriched in the structure at b=0.25 which corresponded to one additional Cl atom per unit cell.

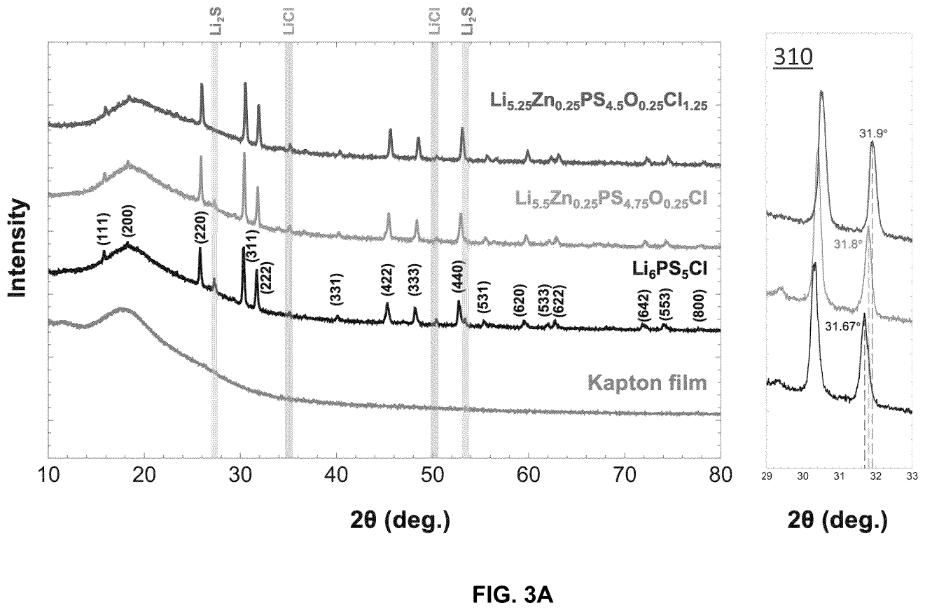

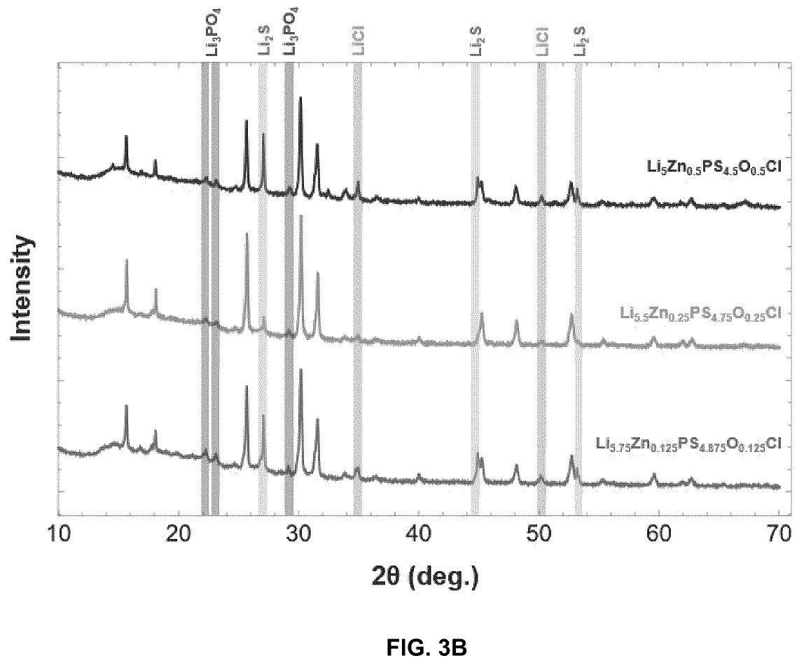

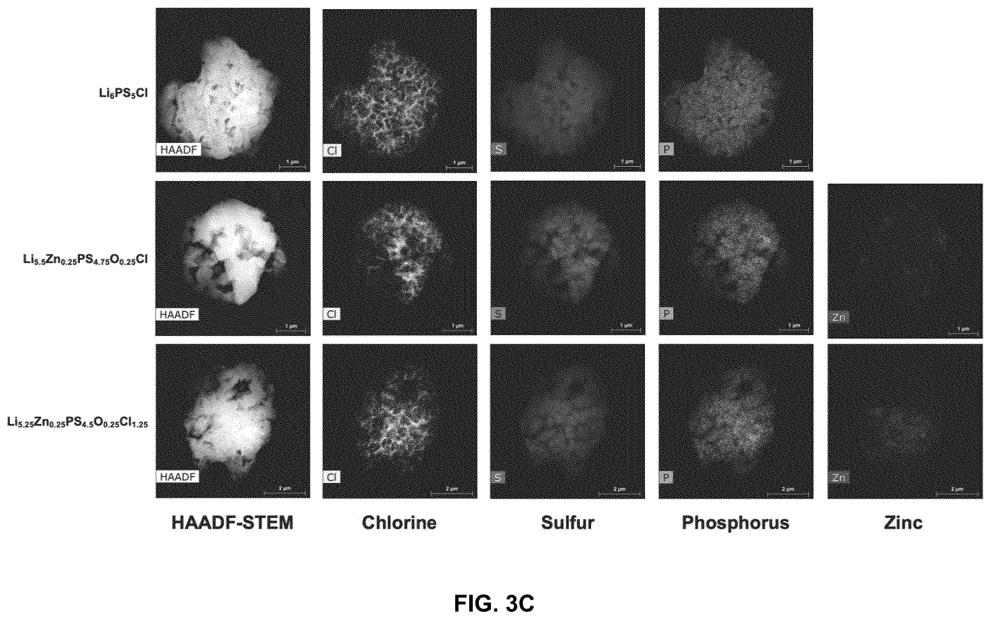

Powder X-ray diffraction (PXRD) indicated that Li₆PS₅Cl, Li_{5.5}Zn_{0.25}PS_{4.75}O_{0.25}Cl, and Li_{5.25}Zn_{0.25}PS_{4.5}O_{0.25}Cl_{1.25} were obtained with minority impurity phases of Li₂S and LiCl, and each displayed peaks corresponding to the F4̅3m space group (FIG. 3A). Introducing ZnO into the argyrodite system at a=0.125 and a=0.5 concentrations resulted in quantities of Li₂S and LiCl precipitating out (FIG. 3B), suggesting that the LPSC system may accommodate one Zn and O per unit cell. Substituting Li⁺ (ionic radius=90 pm) with Zn²⁺ (88 pm) and S²⁻ (170 pm) with O₂ (126 pm) may result in a reduction of the unit cell size and thus a peak shift towards higher 2θ angles was observed (FIG. 3A). Rietveld refinement confirmed a smaller lattice parameter for Li_{5.5}Zn_{0.25}PS_{4.75}O_{0.25}Cl (a=9.8237(2) Å) compared to that of Li₆PS₅Cl (a=9.8598(4) Å). Substitution of Cl⁻ (167 pm) for S²⁻ further reduced the lattice parameter as observed for Li_{5.25}Zn_{0.25}PS_{4.5}O_{0.25}Cl_{1.25} (a=9.8041(8) Å).

High-angle annular dark field scanning transmission electron microscopy (HAADF-STEM) and energy dispersive X-ray spectroscopy (EDS) showed a particle morphology that highlighted the presence of zinc within secondary particles of Li_{5.5}Zn_{0.25}PS_{4.75}O_{0.25}Cl and Li_{5.25}Zn_{0.25}PS_{4.5}O_{0.25}Cl_{1.25} (FIG. 3C).

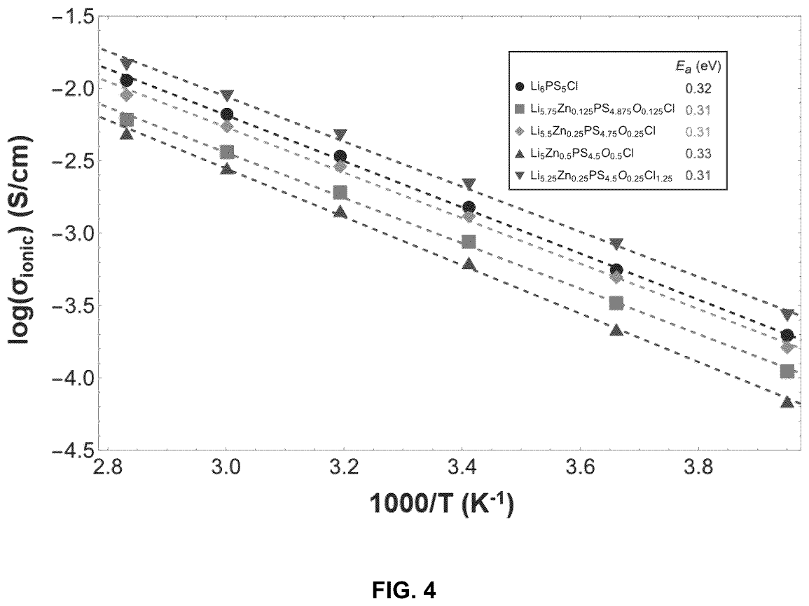

Variations in Ionic and Electronic Conductivity with added ZnO and Chlorine. Using electrochemical impedance spectroscopy (EIS) and chronoamperometry (CA), the ionic and electronic character of LPSC and LZPSOC materials were investigated at about 20° C. Arrhenius plots of LPSC and compounds of LZPSOC are shown in FIG. 4. Ionic conductivity, electronic conductivity, and activation energy measurements from the Arrhenius plots are shown in Table 1. Doping ZnO at a=0.125 and 0.5 resulted in a reduction of the ionic conductivity compared to LPSC. The poor ionic conductors Li₂S and LiCl present in these samples may have lowered the ionic conductivity of these material. Li_{5.5}Zn_{0.25}PS_{4.75}O_{0.25}Cl had an ionic conductivity similar to that of Li₆PS₅Cl. Li_{5.25}Zn_{0.25}PS_{4.5}O_{0.25}Cl_{1.25} had a higher ionic conductivity, lower electronic conductivity, and lower activation energy than Li₆PS₅Cl. Without being bound by any theory, this may be due to a combination of increased Li⁺ vacancy content and a decoupling of the lithium ions from the anion lattice.

TABLE 1
Summary of ionic and electronic conductivities and
activation energies for Li₆PS₅Cl, Li_{5.5}Zn_{0.25}PS_{4.75}O_{0.25}Cl,
Li_{5.25}Zn_{0.25}PS_{4.5}O_{0.25}Cl_{1.25} measured at 20° C.

| | Ionic | Electronic | |
|---|---|---|---|
| | conductivity | conductivity | Activation |
| | at 20° C. | at 20° C. | Energy |
| Sample | (mS cm⁻¹) | (S cm⁻¹) | (eV) |
| Li₆PS₅Cl | 1.51 | 1.02 × 10⁻⁸ | 0.32 |
| Li_{5.5}Zn_{0.25}PS_{4.75}O_{0.25}Cl | 1.31 | 3.03 × 10⁻⁹ | 0.31 |
| Li_{5.25}Zn_{0.25}PS_{4.5}O_{0.25}Cl_{1.25} | 2.16 | 3.36 × 10⁻⁹ | 0.31 |

Samples with ZnO demonstrated lower electronic conductivity than undoped LPSC. The electronic conductivity of Li_{5.5}Zn_{0.25}PS_{4.75}O_{0.25}Cl and Li_{5.25}Zn_{0.25}PS_{4.5}O_{0.25}Cl_{1.25} was an order of magnitude lower than that of Li₆PS₅Cl at 20° C. (Table 1). Solid-state lithium batteries using LZPSOC materials as solid-state electrolytes (SSEs) may demonstrate less dendrite growth at the anode-SSE interface and within the SSE grain boundaries due to the lower electronic conductivity of these materials.

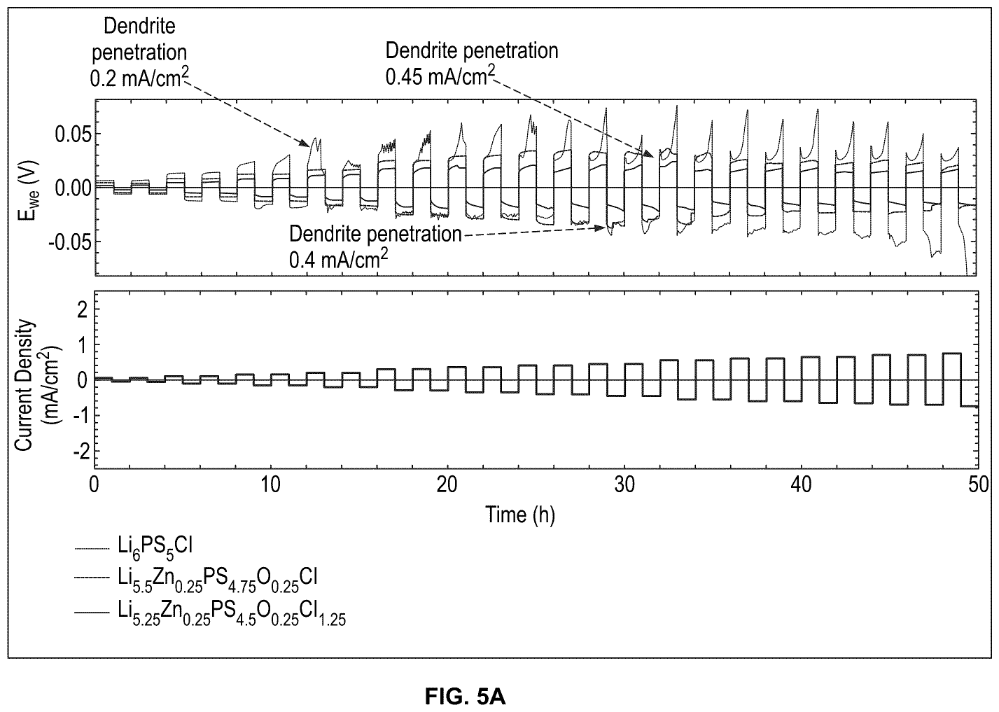

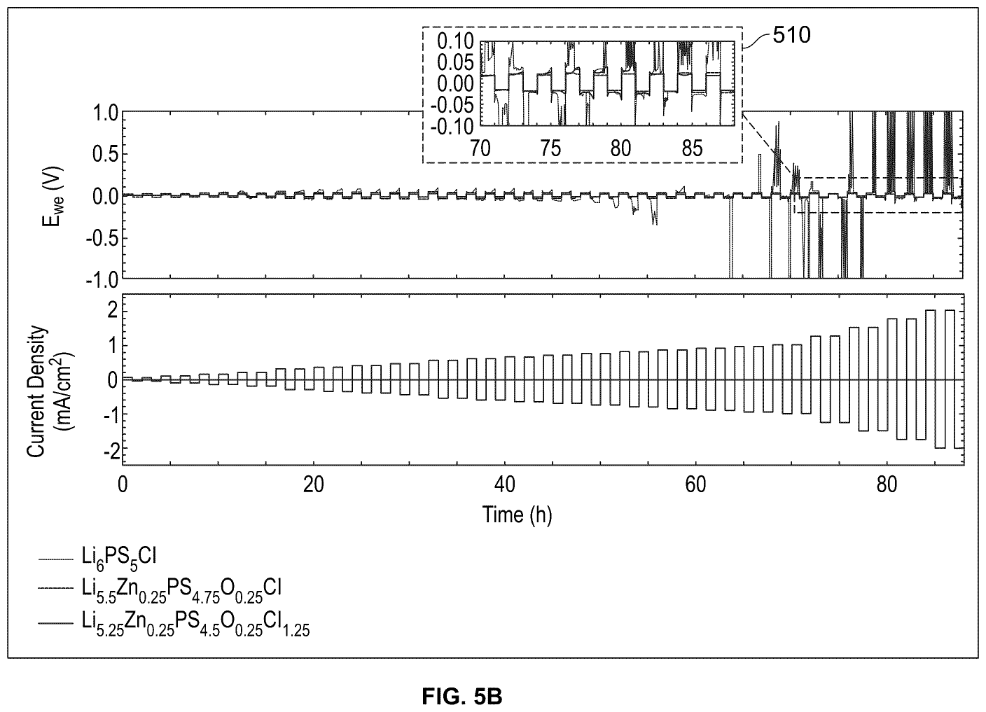

Impact of Dopants on Li∥Li Symmetric Cell Performance. The interfacial stability of LPSC and LZPSOC at the Li metal interface was evaluated. Using pellets pressed from powders of Li₆PS₅Cl, Li_{5.5}Zn_{0.25}PS_{4.75}O_{0.25}Cl, and Li_{5.25}Zn_{0.25}PS_{4.5}O_{0.25}Cl_{1.25}, symmetric cells were assembled and cycled at increasing and constant current densities to measure current density and study the long-term cycling behavior of these materials. Under test conditions (25° C. and a stack pressure of 6 MPa), Li₆PS₅Cl achieved 0.2 mA cm⁻² before dendrite penetration occurred while Li_{5.5}Zn_{0.25}PS_{4.75}O_{0.25}Cl and Li_{5.25}Zn_{0.25}PS_{4.5}O_{0.25}Cl_{1.25} were able to achieve double that at 0.4 mA cm⁻² and 0.45 mA cm⁻², respectively (FIG. 5A). Both Li_{5.5}Zn_{0.25}PS_{4.75}O_{0.25}Cl and Li_{5.25}Zn_{0.25}PS_{4.5}O_{0.25}Cl_{1.25} maintained much lower overpotentials than the pristine argyrodite, even at a relatively high current density of 2.0 mA cm⁻² (FIG. 5B). Specifically, the overpotentials for Li_{5.5}Zn_{0.25}PS_{4.75}O_{0.25}Cl and Li_{5.25}Zn_{0.25}PS_{4.5}O_{0.25}Cl_{1.25} were both less than 0.05 V while the overpotential for Li₆PS₅Cl was greater than 1 V at 2.0 mA cm 2. Without being bound by any theory, this may indicate that doping results in a more favorable interface for lithium plating and stripping as well as less interfacial growth consuming the solid electrolyte. Li_{5.25}Zn_{0.25}PS_{4.5}O_{0.25}Cl_{1.25} maintained a slightly lower overpotential than Li_{5.5}Zn_{0.25}PS_{4.75}O_{0.25}Cl over the course of the test, perhaps because the greater ionic conductivity of the chlorine enriched material providing better transport kinetics.

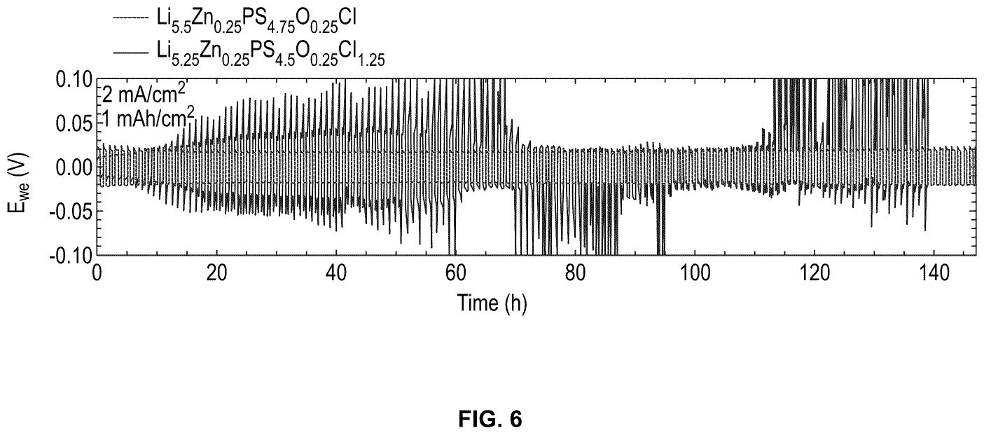

Long term symmetric cell cycling at 2.0 mA cm⁻² was performed on Li_{5.25}Zn_{0.25}PS_{4.5}O_{0.25}Cl_{1.25} and Li_{5.5}Zn_{0.25}PS_{4.75}O_{0.25}Cl to further study their performance at high current densities. An areal capacity of 1.0 mAh cm⁻² indicated electrolyte performance under more realistic conditions. The overpotential for Li_{5.25}Zn_{0.25}PS_{4.5}O_{0.25}Cl_{1.25} started lower than that of Li_{5.5}Zn_{0.25}PS_{4.75}O_{0.25}Cl, but it grew continuously, indicating instability of the interface at this current density and an increase in the interfacial resistance with repeated cycles (FIG. 6). Li_{5.5}Zn_{0.25}PS_{4.75}O_{0.25}Cl showed a relatively stable overpotential with repeated cycling and maintained this behavior for more than 140 hours.

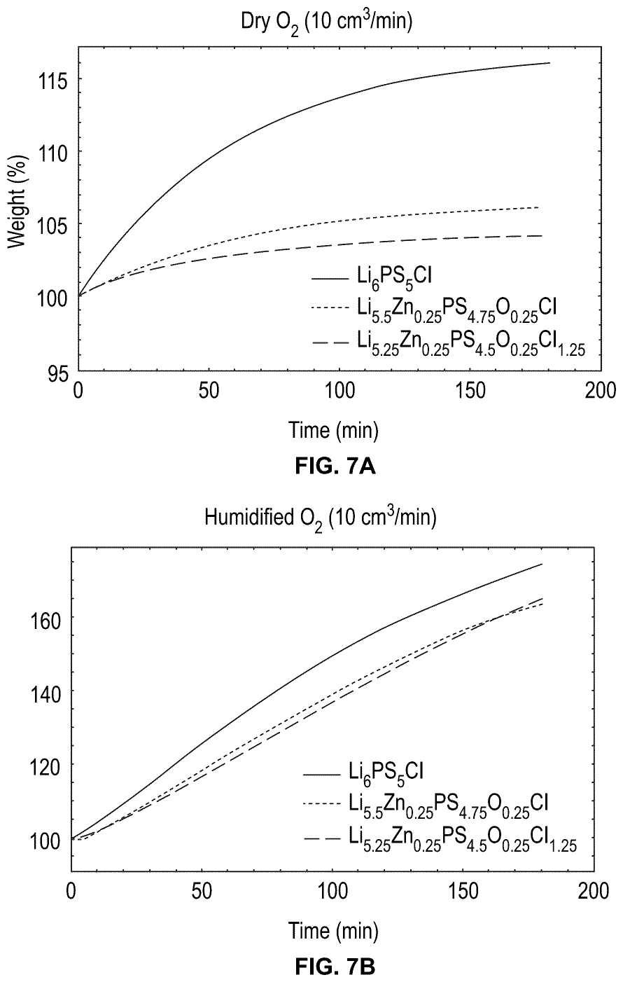

Effect of Dopants on the Stability of Argyrodites towards Ambient Conditions. An understanding of how ZnO doping and Cl enrichment affects the air stability of LPSC was investigated. Argyrodites are known to decompose in humid and oxidizing conditions. Thermogravimetric analysis (TGA) was used to monitor the decomposition of Li₆PS₅Cl, Li_{5.5}Zn_{0.25}PS_{4.75}O_{0.25}Cl, and Li_{5.25}Zn_{0.25}PS_{4.5}O_{0.25}Cl_{1.25} powders when subjected to dry and wet O₂, where increase in mass indicates decomposition. The mass increase may indicate H₂S generation, formation of lithium salts/sulfates, and water adsorption onto the powder particles. The ZnO doped and Cl enriched powders showed less mass gain than pristine LPSC (FIGS. 7A and 7B). The difference in degradation was more pronounced in the case of dry O₂ exposure. These results indicate that ZnO and Cl enrichment may increase the air stability of LPSC.

Doping lithium argyrodites with ZnO and enrichment with LiCl improved electrochemical stability and reduced sensitivity to moisture and oxygen. The argyrodite structure may be maintained even with large amounts of dopants (e.g., one Zn, O, and Cl atom per unit cell) as indicated with XRD. The addition of these dopant atoms increased the ionic conductivity and reduced the material's electronic conductivity. Cycling in Li symmetric cells with relevant current densities and areal capacities was achieved using Li_{5.5}Zn_{0.25}PS_{4.75}O_{0.25}Cl and Li_{5.25}Zn_{0.25}PS_{4.5}O_{0.25}Cl_{1.25} and differences in stability of each material were noted. The overall lower electronic conductivity of the doped materials as well as the formation of beneficial decomposition products may help stabilize the Li-SSE interface during cycling. TGA results indicated that Li_{5.5}Zn_{0.25}PS_{4.75}O_{0.25}Cl and Li_{5.25}Zn_{0.25}PS_{4.5}O_{0.25}Cl_{1.25} exhibited reduced decomposition compared to Li₆PS₅Cl under wet and dry oxygen. Furthermore, the substitution of Li₂S with ZnO and LiCl may be beneficial because of the high cost of Li₂S on the market. By using cheaper precursors ZnO and LiCl in place of Li₂S for synthesis, an overall lower cost solid-state electrolyte can be realized.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A solid-state electrolyte material comprising doped lithium argyrodite of formula of Li_{6-2a-b}MₐTCh_{5-a-b}OₐX_{1+b};
wherein 0<a≤0.5;
wherein 0<b≤0.5;
wherein M is Zn, Mg, Ca, Sr, Be or a combination of any two or more thereof;
wherein T is P, As, Sb, or a combination of any two or more thereof;
wherein Ch is S, Se, or a combination thereof; and
wherein X is F, Cl, Br, I, or a combination of any two or more thereof.

2. The solid-state electrolyte material of claim 1, wherein M is Zn, Ca, or a combination thereof.

3. The solid-state electrolyte material of claim 1, wherein M is Zn, T is P, and Ch is S.

4. The solid-state electrolyte material of claim 1, wherein X is Cl.

5. The solid-state electrolyte material of claim 1, wherein 0.2≤a≤0.3 and 0.2≤b≤0.3.

6. The solid-state electrolyte material of claim 1, wherein the solid-state electrolyte material at about 20° C. has an ionic conductivity greater than about 2.0 mS cm⁻¹ and an electronic conductivity less than about 4×10⁻⁹ S cm⁻¹.

7. The solid-state electrolyte material of claim 1, wherein the doped lithium argyrodite is crystalline.

8. A solid-state lithium battery comprising:
a cathode layer;
an anode layer; and
a solid-state electrolyte layer disposed between the cathode layer and the anode layer, wherein at least one of the cathode layer and the solid-state electrolyte layer comprises the solid-state electrolyte material of claim 1.

9. The solid-state lithium battery of claim 8, wherein the solid-state electrolyte layer comprises about 10 wt. % to about 100 wt. % of the solid-state electrolyte material.

10. The solid-state lithium battery of claim 8, wherein the anode comprises lithium metal.

11. A method of making a solid-state electrolyte material, the method comprising:
mixing powders of LiX, Li₂Ch, T₂Ch₅, and MO to form a mixture, where M is Zn, Mg, Ca, Sr, Be, or a combination of any two or more thereof; T is P, As, Sb or a combination of any two or more thereof; Ch is S, Se, or a combination thereof; and X is F, Cl, Br, I, or a combination of any two or more thereof;
forming the mixture into a pellet, membrane, or film; and
heating the pellet, membrane, or film to form the solid-state electrolyte material.

12. The method of claim 11, wherein heating comprises heating the pellet, membrane, or film at about 450° C. to about 650° C. for about 3 hours to about 10 hours in an inert atmosphere substantially free of oxygen and water.

13. The method of claim 11, wherein mixing comprises mixing amounts of LiX, Li₂Ch, T₂Ch₅, and MO consistent with a stoichiometric of formula Li_{6-2a-b}MₐTCh_{5-a-b}OₐX_{1+b}, wherein 0<a≤0.5 and 0<b≤0.5.

14. The method of claim 13, wherein 0.2≤a≤0.3 and 0.2≤b≤0.3.

15. The method of claim 11, wherein mixing comprises mixing in an inert atmosphere substantially free of oxygen and water.

16. The method of claim 11, wherein M is Zn, Ca, or a combination thereof.

17. The method of claim 11, wherein M is Zn, T is P, and Ch is S.

18. The method of claim 11, wherein X is Cl.

19. A solid-state electrolyte material comprising doped lithium argyrodite of formula of Li_{5.25}Zn_{0.25}PS_{4.5}O_{0.25}Cl_{1.25}.
